(19) United States
(12) Patent Application Publication
(10) Pub. No.: US 2009/0134059 A1
(43) Pub. Date: May 28, 2009

(54) Very Low Sulfur Heavy Crude oil and Porcess for the Production thereof

(76) Inventors: Ronald D. Myers, Calgary (CA); Jame A. Dunn, Calgary (CA)

Correspondence Address: Exxon Mobil Upstream;Research Company, P.O. Box 2189, (CORP-URC-SW 359), Houston, TX, 77252-2189, US

(21) Appl. No.: 12/084,094

(22) PCT Filed: Nov. 7, 2006
(86) PCT No.: PCT/US06/43185

§ 371 Date: Jul. 25, 2008

(30) Foreign Application Priority Data
Dec. 21, 2005 (CA) 2531262

(51) Int. Cl. C10G 45/00; C01B 3/34; C10L 1/04

(52) U.S. Cl. 208/15; 208/228; 208/211; 252/373

(57) ABSTRACT

A process for production of sweet heavy crude oil is disclosed. The process comprises the steps of: removing contaminants from heavy oil, bitumen or bitumen froth to form a substantially dewatered deasphalted oil; and subsequent desulfurization of the substantially dewatered deasphalted oil using sodium metal desulfurization to produce a sweet heavy crude oil. The step of removing contaminants is conducted using extraction with a paraffinic solvent.

This application claims the benefit of Canadian Patent Application No. 2,531,262 filed on Dec. 21, 2005.

### FIELD OF THE INVENTION

The present invention relates generally to a very low sulfur heavy crude oil and a process for its production.

### BACKGROUND OF THE INVENTION

Presently, heavy oil and bitumen are upgraded by either thermal conversion processes which reject carbon typically as coke (delayed coking or fluid coking) or by hydroconversion/hydrocracking processes in which hydrogen is added to the heavy oil to improve properties and reject contaminants such as metals and sulfur. Although thermal conversion processes such as coking are widely practiced throughout the world, these processes are typically capital and operating cost intensive. They require secondary hydrotreating to improve the quality of the coker liquids, they reject up to 25 weight % of the feed as solid coke waste which has little or no value, and in concert with the recovery process they can generate up to 150 kilograms (kg) of CO₂ per barrel of synthetic crude oil (SCO) produced.

Solvent deasphalting processes are practiced commercially for removing some fraction of the asphaltenes from heavy oil, bitumen and residuum. The extent of asphaltene precipitation can be controlled by the nature of the solvent or mixtures thereof used. In addition, the solvent to hydrocarbon feed ratio and the time allowed for asphaltene precipitation may be adjusted to control the extent of asphaltene precipitation.

The process of using sodium and other alkali metals to remove sulfur from heavy oil, bitumen and other petroleum fractions has been described in the patent literature (U.S. Pat. Nos. 1,938,672; 3,785,965; 3,787,315; 3,788,978; 3,791,966; 4,076,613; 4,127,470; 5,695,632; 5,935,421 and 6,210,564). As the patent literature indicates, low cost sodium regeneration is required for an economic sodium desulfurization process for heavy oil and bitumen, or other hydrocarbon feeds.

Some companies utilize steam assisted gravity drainage (SAGD) as the bitumen recovery process, and integrate the upgrading process with bitumen recovery to improve overall energy utilization and project economics. For instance, the OrCrude™ upgrading process involves a continuous loop that fully processes the bitumen feed producing only sour synthetic oil and liquid asphaltenes. It does not generate a solid coke waste by-product that requires disposal. In the first step of the process raw bitumen blended with recycled diluent is fed into a distillation tower where it is separated into 2 streams; a lighter sour overhead stream and the heavier residual bottoms. The overhead stream flows to a hydrocracking unit for upgrading and desulfurization thereby generating premium SCO having 38° API (an American Petroleum Institute measure of specific gravity). The distillation bottoms flow to a solvent deasphalting unit again creating 2 liquid streams. The first stream, the deasphalted oil (DAO) from the deasphalter flows next to the thermal cracker. The thermal cracker which operates at high temperatures, converts the high molecular weight molecules in the DAO into lower molecular weight molecules which are recycled back to the distillation unit. The second stream consists of the liquid asphaltenes which are ultimately converted into syngas in a gasification unit thereby providing hydrogen to the hydrocracker and fuel gas for other processes, including steam generation for SAGD. The overall process yield of SCO is about 81 volume (vol) % based on bitumen feed.

In another example of process integration, others have integrated bitumen extraction and froth treatment with an upgrading process. In this process, which is practiced commercially, aqueous extraction is used as the primary step to separate the bitumen from the oilsand. In the next step, rather than using a naphthenic solvent and centrifuges (which is practiced by some companies to separate the solids and water entrained in the bitumen froth), a paraffinic solvent may be used. The use of a paraffinic solvent results in some fraction of asphaltene precipitation. This asphaltene precipitation facilitates the removal of both solids and water from the bitumen thereby producing a dewatered bitumen which is essentially free of fines and water, and which has lost 5 to 10 weight % as asphaltenes. The removal of this asphaltene fraction increases the API gravity and reduces the viscosity of the bitumen so that a reduced volume of diluent is required for pipeline transportation to the upgrader. By removing the solids and water in concert with the asphaltenes and disposing of them as waste at the mine site, the dewatered, partially deasphalted oil can be upgraded in a resid hydrocracker rather than a coker. Hence by utilizing a paraffinic solvent rather than a naphthenic solvent, the bitumen froth treatment process can be integrated with pipeline transportation and upgrading for overall improved performance.

New upgrading processes may be beneficial to substantially reduce the capital and operating costs of upgrading, to broaden the market for heavy oil and bitumen, and to improve the environmental performance of the upgrading process. New upgrading processes, which enable the economic development of oil sands projects on a smaller scale, are also desirable.

A process that reduces the amount of sodium required for sulfur removal in the preparation of a sweet heavy crude oil may also be advantageous.

### SUMMARY OF THE INVENTION

It is an object of the present invention to provide a process for producing oil. In particular, the present invention provides a process that may be utilized to produce sweet heavy crude oil. According to an embodiment of the invention, there is provided a process for production of very low sulfur heavy crude oil comprising the steps of: extraction of heavy oil, bitumen or bitumen froth with a paraffinic solvent to remove from 5 to 50 weight % asphaltenes, forming a substantially dewatered deasphalted oil containing less than 500 wppm filterable solids and less than 0.1 weight % water; and desulfurization of the substantially dewatered deasphalted oil using sodium metal desulfurization to produce a very low sulfur heavy crude oil.

Additionally, according to a further embodiment of the invention, there is provided a process for production of very low sulfur heavy crude oil comprising the steps of: extraction of heavy oil, bitumen or bitumen froth with a solvent in which a fraction of the asphaltenes is insoluble, to remove from 5 to 50 weight % asphaltenes, forming a substantially dewatered deasphalted oil containing less than 500 wppm filterable solids and less than 0.1 weight % water; and desulfurization of the substantially dewatered deasphalted oil using sodium metal desulfurization to produce a very low sulfur heavy crude oil.

Additionally, an embodiment of the invention provides a process for production of very low sulfur heavy crude oil comprising the steps of: extraction of heavy oil, bitumen or bitumen froth with a paraffinic solvent to remove from 5 to 50 weight % asphaltenes, forming a substantially dewatered deasphalted oil containing less than 500 wppm filterable solids and less than 0.1 weight % water; and desulfurization of the substantially dewatered deasphalted oil using alkaline earth or alkali metal desulfurization to produce a very low sulfur heavy crude oil.

A further embodiment of the invention provides a very low sulfur heavy crude oil comprising less than 0.1 weight % water, less than 0.5 weight % sulfur, and from 15° to 20° API. Preferably, a level of less than 0.1 weight % sulfur is achieved. An exemplary level of less than 0.01 weight % sulfur may be selected. Production of a heavy synthetic crude oil with these unique characteristics has heretofore not been possible. The solvent deasphalting step for removal of an asphaltene fraction maintains within the deasphalted oil many large organic sulfur-containing molecules. By employing sodium desulfurization after partial asphaltene removal, the remaining sulfur atoms can be selectively removed without further yield loss and without discarding the parent molecules. Thus, the step of sulfur removal produces a crude oil at high yield with an API gravity of about 15° to 20° API. Previously, upgraded or synthetic crude oils having a very low sulfur content necessarily require extensive processing, have a much greater API gravity and suffer a higher yield loss.

Advantageously, because this combination process utilizes a step to remove a fraction of the lowest value molecules with the highest sulfur and metals content, as well as entrained water, fines and clays from the heavy oil or bitumen feed, the process can result in a product that is extremely clean, and that can meet pipeline specifications for BS&W (bottom sediments and water), density and viscosity, and is ready for marketing or further downstream processing. Alternatively, products may be formed that require some diluent to meet these specifications, but a reduced amount of diluent may be needed, relative to current procedures. This process can advantageously reduce or eliminate the need for blending with diluent and the increase in product quality associated with sulfur removal leads to an increase in value of the upgraded product. In instances where pipeline transportation is not required, or where pipeline viscosity or density specifications differ, the process allows for flexibility so that the product formed can be formulated accordingly.

As a further advantage, the product produced according to the invention broadens the marketability of the product produced beyond high conversion refineries.

Advantageously, the process according to the invention reduces the amount of sodium required for sulfur removal. The step of removing contaminants and water is conducted first in the process, which removes a substantial amount of water, while fines and clays and the heaviest asphaltenes are precipitated or otherwise removed. Substantial removal of fines and clays is also advantageous in the case of sodium desulfurization with continuous electrolytic sodium regeneration, as metal ions (e.g. Ca²⁺, K⁺) associated with the fines and clays can negatively impact solid electrolyte performance.

The precipitated asphaltenes include some of the sulfur and metals-bearing molecules found in bitumen or heavy oil. Thus, the partially deasphalted oil resulting from the step of extraction requires much less sodium for the sodium metal desulfurization step than would have been required if employing sodium metal desulfurization without first removal of asphaltenes and water. In contrast to conventional processes, the process according to the invention does not require thermal chemistry or thermal conversion followed by severe hydrotreating for sulfur removal.

Other aspects, features, and advantages of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures.

FIG. 1 is a flow chart representing the steps involved according to an embodiment of the invention for producing very low sulfur heavy crude oil.

FIG. 2 is a schematic diagram of the steps involved in processes according to a variety of embodiments of the invention, including optional steps for further downstream processing of sweet heavy crude oil.

### DETAILED DESCRIPTION

Generally, the present invention provides a process for production of a very low sulfur heavy crude oil. Additionally, the invention provides an oil formed as a result of the process.

As used herein, the term “sweet heavy crude oil” is used interchangeably with the term “very low sulfur heavy crude oil”, and both terms are intended to describe the same oil.

The term “deasphalted oil” or DAO is used herein to describe an oil from which a fraction of asphaltenes has been removed. In certain instances herein, the amount of asphaltenes removed from bitumen or heavy oil is specified as from 5 to 50 weight %.

The term “bitumen” as used herein can be understood to encompass bitumen in either an undiluted or diluted form, and bitumen froth.

The invention relates to a process for producing a sweet or very low sulfur, synthetic crude oil from heavy oil or bitumen having a high sulfur content. Once the process is complete, the sweet, heavy crude oil becomes widely marketable and may not be restricted to processing in high conversion refineries.

The process for production of very low sulfur heavy crude oil according to the invention comprises the steps of extraction of heavy oil or bitumen with a paraffinic solvent to remove from 5 to 50 weight % asphaltenes, as well as entrained water, fines and clays thereby forming a substantially dewatered deasphalted oil; and desulfurization of the substantially dewatered deasphalted oil using sodium metal desulfurization to produce a very low sulfur heavy crude oil.

The heavy oil or bitumen that is fed into this process may contain typical amounts of water, as may be found in mined or in situ derived bitumen. For the step of extraction, the oil or bitumen may be processed to contain less than about 0.1 weight % water.

The heavy oil or bitumen that is fed to this process may be obtained from in situ recovery processes such as cold flow, cyclic steam stimulation (CSS) or steam assisted gravity drainage (SAGD). The heavy oil or bitumen that is fed to the process may also be recovered from in situ recovery processes that use a combination of steam and solvent, such as solvent-assisted SAGD (SA-SAGD), or from processes that only use solvent for recovery, such as Vapour Extraction Process (VAPEX). The heavy oil or bitumen that is fed to this process may also be produced from an, oil sands mining process whereby the oil sand is mined in open pits and where the bitumen is extracted from the oil sand with a combination of mechanical shear, heat, water and chemicals to generate bitumen froth. The resulting bitumen froth is then forwarded to froth treatment. The solvents used in commercial froth treatment processing are typically either naphthenic or paraffinic in nature. These mining and extraction processes are practiced commercially in the various geographic locations, such as Athabasca oil sands deposits found in Northern Alberta.

A large portion of free water is removed from the heavy oil, bitumen or bitumen froth in the extraction step, according to the invention. Advantageously, the oil produced in the step of extraction contains less than 0.1 weight % water. Further, as an exemplary level, the oil produced in the step of extraction may contain less than 0.01 weight % water.

Filterable solids primarily include fines and clay that are naturally contained in the heavy oil, bitumen or bitumen froth. The term “filterable solids” as used herein refers to the clay and fines content only, as would be understood by a person skilled in the art. A large portion of the filterable solids can be removed from the heavy oil, bitumen or bitumen froth according to the invention. Advantageously, the oil produced in the step of extraction contains less than 500 weight parts per million (wppm) filterable solids. A preferable level of filterable solids remaining after the step of extraction is less than 200 wppm. Further, as an exemplary level, the oil produced in the step of extraction may contain less than 100 wppm filterable solids.

According to the process, from 5 to 50 weight % asphaltenes, may be removed in the step of extraction. As a further exemplary range, from 5 to 25 weight % asphaltenes may be removed during the step of extraction.

The solvent used for extraction of the heavy oil or bitumen may be any one in which a fraction of the asphaltenes is insoluble. The solvent may be a paraffinic solvent such as C2 to nC7 solvents, their isomers, and mixtures thereof. For example, the solvent may be ethane, in which case the step of extraction may optionally be conducted at a pressure above atmospheric pressure. This range may be narrowed to include C3 to nC7. The range may be narrowed further to nC5 to nC7 solvents, their isomers, and mixtures thereof. Additionally, the paraffinic solvent may be ethane, C3, nC4 or iC4, when the step of extraction is conducted at a pressure above atmospheric pressure.

The paraffinic solvent may be any solvent deemed acceptable in the field. Exemplary solvents include propane, i-butane, n-butane, n-pentane and i-pentane. A variety of solvent to bitumen feed ratios may be used, as would be known to a person of skill in the art. Exemplary ranges of solvent to bitumen feed ratios are from about 1.5:1 to 5:1. Depending on the selection of solvent, the solvent to bitumen froth ratio, or the solvent to bitumen ratio, a different fraction of asphaltenes may be removed. For example, with propane, a greater fraction of asphaltenes may be removed than with n-pentane, and thus the solvent can be selected on the basis of desired sodium desulfurized bitumen product quality and downstream processing requirements.

Optionally, the step of extraction may be conducted at a pressure above atmospheric pressure if it is so desired for the particular requirements of the process.

The process of the invention may be conducted in a continuous process, or as a batch process. Advantageously, as a continuous process, a constant high-throughput may be realized. The extraction step may be conducted in a vessel or separation zone which feeds the substantially dewatered deasphalted oil into a sodium desulfurization reaction zone. The reaction zone may be a single vessel, or a number of modules, each of which may contribute to the full capacity of the process. Advantageously, the number of modules can be designed so that one or more module could be closed at any given time while allowing the system to still process oil at full capacity.

The step of desulfurization may be conducted according to any known method, such as the methods described in U.S. Pat. No. 1,938,672 (Ruthruff) or U.S. Pat. No. 4,076,613 (Bearden), whereby sodium metal desulfurization comprises contacting said substantially dewatered deasphalted oil with sodium metal in an amount of at least two moles of sodium and one mole of hydrogen gas (H₂) per mole of sulfur removed, in a reaction zone maintained at a temperature of about 275° C. or greater. Optionally, the step of desulfurization may be carried out at temperatures in excess of 400° C. and/or for periods of time long enough to initiate thermal conversion chemistry in order to produce a very low sulfur crude oil which has substantially reduced viscosity and an API gravity greater than 15 to 20 degrees API.

Optionally, the step of desulfurization may be conducted according to the method taught in U.S. Pat. No. 6,210,564 (Brons et al.), which involves sodium metal desulfurization through contacting the substantially dewatered deasphalted oil with sodium metal using staged addition at a temperature of about 250° C. or greater in the presence of a molar excess of hydrogen gas (H₂) to sodium metal of at least 1.5:1. Staged addition of sodium metal, as taught by this reference can be accomplished by discrete additions of sodium to the oil over the course of a reaction period. This desulfurization process suppresses formation of Na₂S, and promotes formation of NaSH.

The process is capable of producing very low sulfur heavy crude oil having a sulfur content of less than 0.5 weight %, or preferably less than 0.1 weight %. As an exemplary level of sulfur, less than 0.01 weight % may be present. The oil produced has 0.1 weight % water or less. The API gravity of the oil so produced may range from 15° to 20°. This is particularly advantageous considering that a product can be produced that meets the pipeline transportation requirements, such as the transportation requirements for Western Canadian pipeline specifications (19° API at 15° C. and 350 centistokes (cSt) at ground temperature. Because the API gravity can be manipulated according to this process to a level acceptable for pipeline transportation, a number of downstream applications are available for the oil product produced according to this process. The product produced according to the process may also be formulated so that a reduced amount of diluent is required to meet a desired density or viscosity specification. Optionally, sodium may be recovered from the process according to the invention and recycled for use in the desulfurization step or in unrelated applications.

Alkaline earth or alkali metal desulfurization may be employed according to the invention, which incorporates alkaline earth or alkali metals other than just sodium. For example, the alkali metal may be potassium, lithium, combinations of potassium and lithium, or combinations of these with sodium. Similarly, the alkaline earth metals calcium and magnesium or combinations thereof may also be used.

The process uses solvent deasphalting integrated with sodium desulfurization of bitumen and heavy oil to substantially improve process performance and process economics. A reduction in the mass of sodium required to desulfurize the oil is realized with this process. A reduction in sodium consumption of up to 20% can be realized by performing the solvent deasphalting step prior to sodium desulfurization. Furthermore, continuous electrolytic regeneration of the sodium via beta-alumina electrolyte is facilitated by substantial removal of fines and clays in the first step.

The process employs a combination of steps for sulfur and metals removal from heavy oil and bitumen which substantially broadens the market for the resulting sweet heavy crude. This process further enables subsequent processing such that the remaining residual fraction or bottoms of the sweet heavy crude may be utilized as high value fuel after separation since high capital and operating cost flue gas desulfurization may not be required, or a reduced requirement may be realized, to enable their economic utilization as fuel in combustion processes.

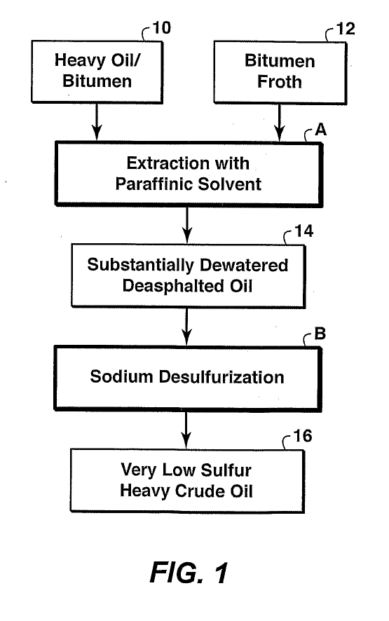

FIG. 1 illustrates a basic process for production of very low sulfur heavy crude oil according to an embodiment of the invention. Briefly, either heavy oil or bitumen (10) or bitumen forth (12) is extracted with a paraffinic solvent. In the extraction step (A), a paraffinic solvent is used, and from 5 to 50 weight % asphaltenes are removed. The paraffinic solvent is recovered from the deasphalted oil (DAO) and recycled through the extraction process as is known to those skilled in the art. A substantially dewatered deasphalted oil (14) is formed. The substantially dewatered deasphalted oil then undergoes the step of sodium desulfurization (B), using sodium metal. As a result, a very low sulfur heavy crude oil (16) is produced.

The process of the invention offers a substantial improvement to the sodium desulfurization process because the pre-treatment separation step removes unwanted water from the bitumen and heavy oil and further reduces the sulfur and metals content of the bitumen and heavy oil by rejecting a fraction of the asphaltene molecules in which these latter contaminants reside. The rejection of water, and the rejection of sulfur and metals with the asphaltenes results in a reduction in the molar mass of sodium required in the second step of the process. The process is capable of producing a very low sulfur (<0.5 weight %), low metals (<50 weight parts per million (wppm) and preferably less than 25 wppm), sweet heavy crude oil, thereby enhancing the economics of sodium desulfurization and sodium regeneration in a continuous process.

Furthermore, by adjusting and optimizing the mass fraction of low value asphaltenes rejected in the pre-treatment step a sweet, heavy crude oil which meets Western Canadian pipeline specifications (19° API and 350 cSt) may easily be produced. In addition to the product quality enhancements described above, the combination of solvent deasphalting or other separation followed by sodium desulfurization produces a unique sweet heavy crude with an associated substantial reduction in green house gas emissions. The by-products from this combination process are asphaltenes which are rejected and disposed at the production site, and sulfur and metals from the desulfurization process. In contrast to other upgrading processes and apart from carbon dioxide (CO₂) emissions associated with hydrogen production, the sodium desulfurization process does not generate any CO₂ or sulfur dioxide (SO₂) emissions.

The product formed according to the invention can be further processed or enhanced in optional steps, which are considered as alternative embodiments of the invention. The process may additionally comprise one or more downstream processing steps which may lead to the preparation of premium sweet crude oil; preparation of syngas; preparation of low sulfur, low metals coke; preparation of a low sulfur, low metals bottoms stream as fuel for combustion or gasification; or production of very low sulfur naphtha, distillate and gas oil. Such downstream processing steps are well known to those of skill in the art.

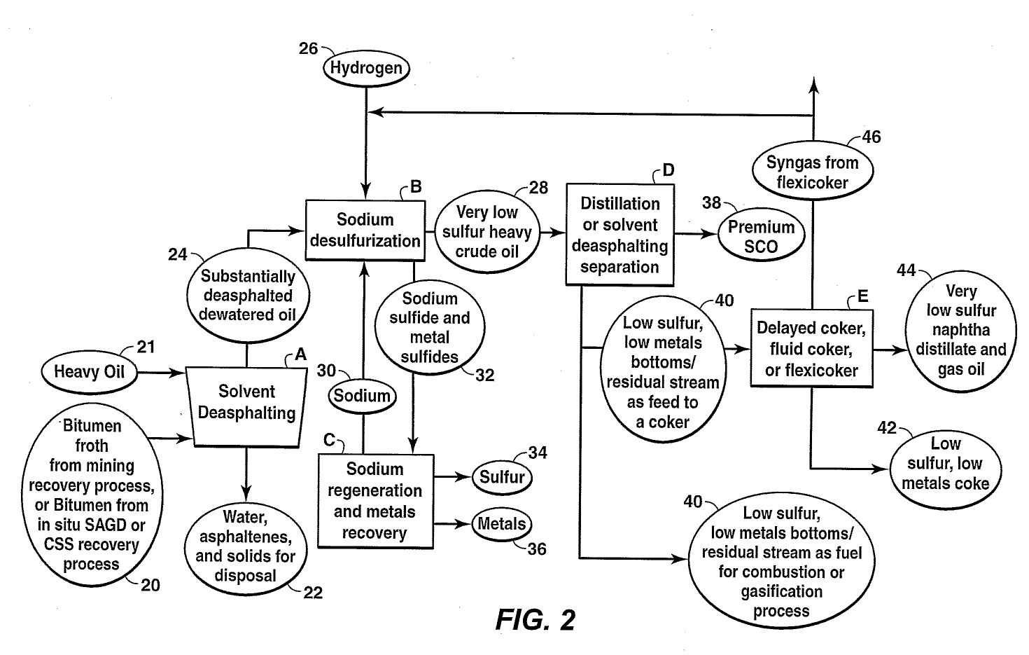

FIG. 2 shows a flow chart illustrating a number of exemplary embodiments of the process, along with a variety of optional downstream processing steps. The process results in the production of a unique heavy, sweet crude oil with very low metals (nickel and vanadium) content which may meet pipeline specifications for density and viscosity, or which may require a reduced amount of diluent in order to meet these specifications.

The starting materials for the process of the invention are shown in FIG. 2. Either bitumen (20) or heavy oil (21) is processed in step (A) by solvent deasphalting. Bitumen may be in the form of bitumen froth from mining recovery processes or the bitumen may be derived from in situ SAGD or CSS recovery processes. As a result of the solvent deasphalting separation step (A), water, asphaltenes and solids are produced for disposal (22). A number of solvents, as discussed herein, may be employed, for example C2, C3 to nC7 solvents, their isomers, and mixtures thereof. Optionally, when the step of extraction is conducted at a pressure above atmospheric pressure, ethane, C3 or nC4 may be used as the solvent.

The substantially dewatered deasphalted oil (24) resulting from the solvent deasphalting process is subjected to the processing step of sodium desulfurization (B), which can be conducted according to any number of procedures, as would be known to those skilled in the art. For example, sodium desulfurization may be conducted by using, within a reaction zone at 275-350° C. or greater, sodium metal in an amount of at least two moles of sodium and one mole of hydrogen gas (H₂) per mole of sulfur removed. Alternative desulfurization methods may be used, such as using a reduced amount of sodium metal in staged additions at 250° C. or greater in the presence of a molar excess of hydrogen to sodium metal of at least 1.5:1. Requirements for the desulfurization processing step may include hydrogen (26) and sodium (30), and by-products of the processing step may include sodium sulfide and metal sulfides (32). Such by-products may go on to sodium regeneration and metals recovery (C), if desired, so as to produce sulfur (34) and metals (36).

The main product of the sodium desulfurization step (B) is very low sulfur heavy crude oil (28). After vacuum distillation or solvent deasphalting (D) the low sulfur heavy oil residuum or asphaltenes, respectively may be used as feed to a delayed coker, fluid coker, or flexicoker (E). In the latter case, a byproduct may be syngas (46) (from a flexicoker), which could then be used to supply hydrogen (26) for the subsequent use in sodium desulfurization processes (B). Low sulfur, low metals coke (42) may also be formed. The very low sulfur naphtha, distillate and gas oil (44) so formed may be of considerable value and extremely low in sulfur. The very low sulfur heavy crude oil (28) may alternatively go on to distillation or further solvent deasphalting separation (D), so as to form a low sulfur, low metals bottoms stream (40) as fuel for combustion or gasification. In this instance, the product of the separation (D) may be premium sweet crude oil (38), of an exceptionally high quality, containing extremely low metals, and in the case of distillation, no metals. Specific embodiments are discussed in more detail below.

According to one alternative embodiment including additional optional processing steps, the sweet heavy crude oil residuum or asphaltenes (40) produced may be used as feed to a delayed coker or a fluid coker (E) resulting in improved liquid yields of low sulfur naphtha, distillate and gas oil (44). This embodiment may also result in the production of low sulfur, low metals coke (42) that may be used as fuel without the need for high cost flue gas desulfurization facilities. The low sulfur, low metals coke subsequently produced from a delayed or fluid coker may also be gasified to generate syngas (H₂ and CO) as fuel for steam generation. In this way integration with the recovery process is facilitated. Further, syngas-derived hydrogen (26) can be used to supply the hydrogen needed in the sodium desulfurization process and to secondary upgrading. This negates the requirement for additional sulfur clean-up in either case.

Furthermore, the sweet heavy crude oil residuum or asphaltenes (40) produced may be utilized as feed to a flexicoker (step E), resulting in production of very low sulfur coker liquids (44) and syngas (46), the latter of which may be utilized as fuel gas as in the case of integration with SAGD or other recovery process. Alternatively, it may be used as a source of hydrogen (26) for the sodium desulfurization process and for secondary upgrading. In both cases, the requirement for expensive sulfur removal facilities is reduced or eliminated.

In another alternative embodiment involving an optional processing step, the sweet heavy crude oil produced can be further processed whereby the heavy hydrocarbon molecules (residuum, asphaltenes) are separated (D) to produce a premium, light, sweet, bottomless synthetic crude oil (38) with enhanced value, and very low sulfur/low metals bottoms (40). The latter bottoms product may be used as a low sulfur fuel which may not require or has a reduced requirement for expensive flue gas desulfurization, or gasified to produce syngas. This separation step (D) may be conducted by boiling point as in distillation, or by solubility as in solvent deasphalting. The yield of premium, light, sweet crude is between 60 to 80% by volume based on feed of sweet heavy crude oil.

FIG. 2 illustrates an embodiment of the inventive process for mined oil sands in which aqueous extraction is used as the primary separation process to separate the bitumen from the sand and produce bitumen froth (20). A solvent deasphalting process (step A) designed to remove from 5 to 25 weight % of the asphaltenes is then utilized to facilitate water removal and removal of the solids (fines and clays) entrained in the froth. The solids, asphaltenes and water (22) may then be disposed in the mine. The resulting asphaltene-reduced oil (24) with a yield of 75 to 95 weight % relative to bitumen froth feed exhibits increased API gravity, reduced viscosity, reduced asphaltene and residua content, reduced metals and reduced sulfur content.

The improvement between bitumen and the asphaltene-reduced bitumen properties from solvent deasphalting (A) is proportional to the amount of asphaltenes rejected during this step. In addition to rejecting these undesirable components of the bitumen, the solvent deasphalting process produces bitumen having a very low water content, as well as having a low content of fines and clays. The removal from the bitumen of entrained water, and asphaltenes which are high in sulfur and metals content, results in a substantial reduction in the molar mass of sodium required during sodium desulfurization (B) for complete sulfur removal and thereby substantially reduces the cost of sodium regeneration and metals recovery (C) in a continuous process. Furthermore, substantial removal of fines and clays in the first step facilitates continuous electrolytic regeneration of the sodium via beta-alumina electrolyte by reducing the amount of associated metal ions (e.g. Ca²⁺, K⁺) which if carried with the sodium-sulfur cell feed can impair the conductivity and operation of the electrolyte.

In further optional steps of the present embodiment, the bitumen may be extracted from oil sand using a non-aqueous solvent (e.g. naphthenic or paraffinic-based, or a combination thereof where the bitumen extraction step is integrated with solvent deasphalting (A) to improve bitumen extraction recovery and to improve overall process economics.

The mass fraction of asphaltenes rejected in the pre-treatment step is on the order of 5 to 25 weight %. This level can be manipulated and optimized according to the separation process used. When using solvent deasphalting, the yield of substantially dewatered deasphalted oil (24), the desired properties and qualities of the very low sulfur heavy crude oil (28), and the desired reduction in sodium requirement (30) in the sodium desulfurization process (B) can be controlled by the fraction of asphaltenes rejected. The reduction in sodium requirement and the improvement in sweet heavy crude oil properties are proportional to the mass fraction of asphaltenes rejected. This can easily be controlled by the user, depending on the solvent and conditions selected.

FIG. 2 illustrates a further embodiment of the process in which very low sulfur heavy crude oil (28) produced from the combination of solvent deasphalting (A) followed by sodium desulfurization (B) is used as feed to a delayed coker (E) after vacuum distillation or other separation (D). In this case the mass fraction of asphaltenes (22) rejected in the solvent deasphalting step (A) is optimized primarily for water and fines rejection, however some level of asphaltene rejection is required to produce a sweet heavy crude oil with very low sulfur and metals content. In this case, it is desirable to maximize the yield of sweet heavy crude oil as feed to the coker in order to maximize the liquid yield from the coking process. The low sulfur, low metals coke (42) from the coking process may be utilized as fuel at the upgrader, it may be sold as higher value anode grade coke or it may be gasified to produce syngas (46) and hydrogen for secondary hydrotreating. The production of low sulfur coke as fuel may eliminate the need for high cost flue gas desulfurization in processes that utilize the coke as fuel. Hence the process converts low value waste coke to a high value fuel.

In a further embodiment of the invention, a combination of solvent deasphalting (A) followed by sodium desulfurization (B) may be utilized to upgrade the quality of bitumen produced by in situ recovery processes to produce a very low sulfur heavy crude oil (28) that meets pipeline specifications, that eliminates the need for diluent and that enhances the value of the bitumen or heavy oil. In this embodiment of the combination process, bitumen or heavy oil (20,21) produced, for example, by cyclic steam stimulation (CSS) or SA-SAGD is de-watered and a fraction of the asphaltenes are rejected (22) in the solvent deasphalting process (A). The rejected asphaltenes (22) may be re-injected into a depleted reservoir for disposal. The resulting substantially dewatered deasphalted oil (24) is then used as feed to the sodium desulfurization process (B) to produce very low sulfur heavy crude oil with enhanced properties and value, and sulfur (34) and metals (36) are formed as by-product streams from the sodium regeneration and metals recovery process (C). The recovered sulfur (34) and metals (36) may be sold, market conditions permitting. Upon further processing, a fraction of the sweet heavy crude (28) that has been distilled or otherwise subjected to further separation (D) to produce a product (40), may be used as fuel to generate steam for the thermal in situ recovery process thereby eliminating the need to purchase and burn high cost natural gas. The combustion of sweet heavy crude oil to produce steam eliminates the need for high cost flue gas desulfurization (FGD) equipment in the case when desulfurized bitumen or heavy oil, or some fraction thereof, is burned directly.

The combination of solvent deasphalting (A) followed by sodium desulfurization (B) generates a very low sulfur heavy crude that may be utilized as fuel in a combustion process without the need for FGD. Removal of sulfur from heavy oil or bitumen prior to their use as fuel in a combustion process utilizing the invention described herein offers a substantial reduction in cost relative to sulfur emissions capture by commercial flue gas desulfurization processes. The invention broadens the use of heavy oil and bitumen or fractions thereof as a fuel in combustion processes.

In the step (A) when solvent deasphalting is employed, the selection of solvent can be used to manipulate the quantity and type of asphaltene fractions removed, depending on solubility within the selected solvent. Exemplary solvents which may be used to extract bitumen are provided below, along with certain characteristics of the resulting substantially dewatered deasphalted oil.

### EXAMPLE 1

### Asphaltene-Reduced Dewatered Oil from 8:1 Extraction of Bitumen with nC4

Bitumen obtained from Cold Lake, Alberta was extracted with nC4 (butane) solvent using a solvent to bitumen ratio of 8:1. The bitumen contained 4.84 weight % sulfur, 81.21 weight % carbon, and had an initial API gravity of about 10.1. The resulting asphaltene-reduced dewatered oil fraction represented 72.8 weight % of the starting weight of bitumen, while the remaining asphaltene fraction represented 27.2 weight % of the starting weight of bitumen. The deasphalted oil fraction contained 0.01 weight % water, and had an ash content of less than 0.2 weight %. The oil fraction contained 84.15 weight % carbon, 10.77 weight % hydrogen, and less than 0.5 weight % nitrogen. The sulfur content was reduced to 3.77 weight %. The API gravity of the resulting oil was 16.0° API. The asphaltene fraction contained 7.65 weight % sulfur. The deasphalted oil fraction derived from this example which has a reduced sulfur content and improved API gravity can be used as feed to the sodium desulfurization process thereby producing a sweet heavy crude oil with a very low sulfur content.

### EXAMPLE 2

### Asphaltene-Reduced Dewatered Oil from 4:1 Extraction of Bitumen with nC4

Bitumen obtained from Cold Lake, Alberta was extracted with nC4 (butane) solvent using a solvent to bitumen ratio of 4:1. The bitumen contained 4.84 weight % sulfur, 81.21 weight % carbon, and had an initial API gravity of about 10.1. The resulting asphaltene-reduced dewatered oil fraction represented 71.6 weight % of the starting weight of bitumen, while the remaining asphaltene fraction represented 28.4 weight % of the starting weight of bitumen. The deasphalted oil fraction contained <0.03 weight % water, and had an ash content of less than 0.21 weight %. The oil fraction contained 84.67 weight % carbon, 10.99 weight % hydrogen, and about 0.73 weight % nitrogen. The sulfur content was reduced to 3.56 weight %. The API gravity of the resulting oil was 15.9° API. The asphaltene fraction contained 7.66 weight % sulfur. The deasphalted oil fraction derived from this example which has a reduced sulfur content and improved API gravity can be used as feed to the sodium desulfurization process thereby producing a sweet heavy crude oil with a very low sulfur content.

### EXAMPLE 3

### Asphaltene-Reduced Dewatered Oil from Extraction of Bitumen with iC4

Bitumen obtained from Cold Lake, Alberta was extracted with iC4 (isobutane) solvent using a solvent to bitumen ratio of 8:1. The bitumen contained 4.84 weight % sulfur, 81.21 weight % carbon, and had an initial API gravity of about 10.1. The resulting asphaltene-reduced dewatered oil fraction represented 64.1 weight % of the starting weight of bitumen, while the remaining asphaltene fraction represented 35.9 weight % of the starting weight of bitumen. The deasphalted oil fraction contained <0.01 weight % water, and had an ash content of less than 0.18 weight %. The oil fraction contained 84.03 weight % carbon, 11.14 weight % hydrogen, and less than about 0.5 weight % nitrogen. The sulfur content was reduced to 3.42 weight %. The API gravity of the resulting oil was 17.8° API. The asphaltene fraction contained 7.00 weight % sulfur. The deasphalted oil fraction derived from this example which has a reduced sulfur content and improved API gravity can be used as feed to the sodium desulfurization process thereby producing a sweet heavy crude oil with a very low sulfur content.

### EXAMPLE 4

### Asphaltene-Reduced Dewatered Oil from Extraction of Bitumen with C3

Bitumen obtained from Cold Lake, Alberta was extracted with C3 (propane) solvent using a solvent to bitumen ratio of about 8:1. The bitumen contained 4.84 weight % sulfur, 81.21 weight % carbon, and had an initial API gravity of about 10.1. The resulting asphaltene-reduced dewatered oil fraction represented 52.2 weight % of the starting weight of bitumen, while the remaining asphaltene fraction represented 47.8 weight % of the starting weight of bitumen. The oil fraction contained <0.01 weight % water, and had an ash content of less than 0.15 weight %. The deasphalted oil fraction contained 84.75 weight % carbon, 12.13 weight % hydrogen, and less than about 0.5 weight % nitrogen. The sulfur content was reduced to 2.97 weight %. The API gravity of the resulting oil was 19.8° API. The asphaltene fraction contained 6.87 weight % sulfur. The deasphalted oil fraction derived from this example which has a reduced sulfur content and improved API gravity can be used as feed to the sodium desulfurization process thereby producing a sweet heavy crude oil with a very low sulfur content.

The above-described embodiments of the present invention are intended to be examples only. Alterations, modifications and variations may be effected to the particular embodiments by those skilled in the art without departing from the scope of the invention, which is defined solely by the claims appended hereto.

What is claimed is:

1. A process for production of very low sulfur heavy crude oil comprising the steps of:
extraction of heavy oil, bitumen or bitumen froth with a paraffinic solvent to remove from 5 to 50 weight % asphaltenes, forming a substantially dewatered deasphalted oil containing less than 500 weight parts per million (wppm) filterable solids and less than 0.1 weight % water; and
desulfurization of the substantially dewatered deasphalted oil using sodium metal desulfurization to produce a very low sulfur heavy crude oil.

2. The process of claim 1, wherein the substantially dewatered deasphalted oil produced in the step of extraction contains less than 200 wppm filterable solids.

3. The process of claim 2, wherein the substantially dewatered deasphalted oil produced in the step of extraction contains less than 0.01 weight % water.

4. The process of any one of claims 1 to 3, wherein from 5 to 25 weight % asphaltenes are removed in the step of extraction.

5. The process of any one of claims 1 to 4, wherein the paraffinic solvent is selected from the group consisting of C2 to nC7 solvents, their isomers, and mixtures thereof.

6. The process of claim 5, wherein the paraffinic solvent is ethane, C3, nC4 or iC4, and the step of extraction is conducted at a pressure above atmospheric pressure.

7. The process of claim 5, wherein the paraffinic solvent is selected from the group consisting of nC5 to nC7 solvents, their isomers, and mixtures thereof.

8. The process of any one of claims 1 to 7, wherein the steps are conducted in a continuous process.

9. The process of any one of claims 1 to 8, wherein sodium metal desulfurization comprises contacting the substantially dewatered deasphalted oil with sodium metal in an amount of at least two moles of sodium and one mole of hydrogen gas (H₂) per mole of sulfur removed, in a reaction zone maintained at a temperature of 275° C. or greater.

10. The process of claim 9 wherein the reaction zone is maintained at a temperature of 400° C. or greater.

11. The process of any one of claims 1 to 8, wherein sodium metal desulfurization comprises contacting the substantially dewatered deasphalted oil with sodium metal using staged addition at a temperature of about 250° C. or greater in the presence of a molar excess of hydrogen to sodium metal of at least 1.5:1.

12. The process of any one of claims 1 to 11, wherein the very low sulfur heavy crude oil produced has a sulfur content of less than 0.5 weight %.

13. The process of claim 12, wherein the very low sulfur heavy crude oil produced has a sulfur content of less than 0.1 weight %.

14. The process of claim 12, wherein the very low sulfur heavy crude oil produced has a sulfur content of less than 0.01 weight %.

15. The process of any one of claims 1 to 14, wherein bitumen froth is used in the step of extraction.

16. The process of any one of claims 1 to 14, wherein in situ derived bitumen or heavy oil is used in the step of extraction.

17. The process of any one of claims 1 to 16, additionally comprising a downstream step selected from the group consisting of preparation of premium sweet crude oil; preparation of syngas; preparation of low sulfur, low metals coke; preparation of a low sulfur, low metals bottoms stream as fuel for combustion or gasification; production of very low sulfur naphtha, distillate and gas oil.

18. The process of any one of claims 1 to 17, wherein sodium is recovered from and recycled for use in the desulfurization step.

19. A process for production of very low sulfur heavy crude oil comprising the steps of:
extraction of heavy oil, bitumen or bitumen froth with a solvent in which a fraction of the asphaltenes is insoluble, to remove from 5 to 50 weight % asphaltenes, forming a substantially dewatered deasphalted oil containing less than 500 weight parts per million (wppm) filterable solids and less than 0.1 weight % water; and
desulfurization of the substantially dewatered deasphalted oil using sodium metal desulfurization to produce a very low sulfur heavy crude oil.

20. A process for production of very low sulfur heavy crude oil comprising the steps of:
extraction of heavy oil, bitumen or bitumen froth with a paraffinic solvent to remove from 5 to 50 weight % asphaltenes, forming a substantially dewatered deasphalted oil containing less than 500 weight parts per million (wppm) filterable solids and less than 0.1 weight % water; and
desulfurization of the substantially dewatered deasphalted oil using alkaline earth or alkali metal desulfurization to produce a very low sulfur heavy crude oil.

21. The process of claim 19 or claim 20, wherein the substantially dewatered deasphalted oil produced in the step of extraction contains less than 200 wppm filterable solids.

22. The process of any one of claims 19 to 21, wherein the substantially dewatered deasphalted oil produced in the step of extraction contains less than 0.01 weight % water.

23. The process of any one of claims 19 to 22, wherein from 5 to 25 weight % asphaltenes are removed in the step of extraction.

24. The process of claim 20 wherein the alkali metal desulfurization includes alkali metals comprising potassium, lithium or a combination thereof.

25. The process of claim 24 wherein the alkali metal additionally comprises sodium.

26. The process of claim 20 wherein the alkaline earth metal desulfurization includes alkaline earth metals comprising calcium, magnesium or a combination thereof.

27. A very low sulfur heavy crude oil produced according to the process of any one of claims 1 to 26 having from 15° to 20° API.

28. A very low sulfur heavy crude oil comprising less than 0.1 weight % water, less than 0.5 weight % sulfur, and from 15° to 20° API.

29. The oil of claim 28 comprising less than 0.1 weight % sulfur.

30. The oil of claim 28 comprising less than 0.01 weight % sulfur.

31. The oil of any one of claims 28 to 30 comprising less than 0.01 weight % water.

32. The oil of any one of claims 28 to 31 comprising less than 50 wppm metals.

33. The oil of claim 32 comprising less than 25 wppm metals.

34. A method for production of very low sulfur heavy crude oil comprising the steps of:
extraction of heavy oil, bitumen or bitumen froth with a paraffinic solvent to remove from 5 to 50 weight % asphaltenes, forming a substantially dewatered deasphalted oil containing less than 500 weight parts per million (wppm) filterable solids and less than 0.1 weight % water; and
desulfurization of the substantially dewatered deasphalted oil using sodium metal desulfurization to produce a very low sulfur heavy crude oil.

35. The process of claim 34, wherein the substantially dewatered deasphalted oil produced in the step of extraction contains less than 200 wppm filterable solids.

36. The process of claim 35, wherein the substantially dewatered deasphalted oil produced in the step of extraction contains less than 0.01 weight % water.

37. The process of claim 34, wherein from 5 to 25 weight % asphaltenes are removed in the step of extraction.

38. The process of claim 34, wherein the paraffinic solvent is selected from the group consisting of C2 to nC7 solvents, their isomers, and mixtures thereof.

39. The process of claim 38, wherein the paraffinic solvent is ethane, C3, nC4 or iC4, and the step of extraction is conducted at a pressure above atmospheric pressure.

40. The process of claim 38, wherein the paraffinic solvent is selected from the group consisting of nC5 to nC7 solvents, their isomers, and mixtures thereof.

41. The process of claim 34, wherein the steps are conducted in a continuous process.

42. The process of claim 34, wherein sodium metal desulfurization comprises contacting the substantially dewatered deasphalted oil with sodium metal in an amount of at least two moles of sodium and one mole of hydrogen gas (H₂) per mole of sulfur removed, in a reaction zone maintained at a temperature of 275° C. or greater.

43. The process of claim 42 wherein the reaction zone is maintained at a temperature of 400° C. or greater.

44. The process claim 34, wherein sodium metal desulfurization comprises contacting the substantially dewatered deasphalted oil with sodium metal using staged addition at a temperature of about 250° C. or greater in the presence of a molar excess of hydrogen to sodium metal of at least 1.5:1.

45. The process of claim 34, wherein the very low sulfur heavy crude oil produced has a sulfur content of less than 0.5 weight %.

46. The process of claim 34, wherein the very low sulfur heavy crude oil produced has a sulfur content of less than 0.1 weight %.

47. The process of claim 34, wherein the very low sulfur heavy crude oil produced has a sulfur content of less than 0.01 weight %.

48. The process of claim 34, wherein bitumen froth is used in the step of extraction.

49. The process of claim 34, wherein in situ derived bitumen or heavy oil is used in the step of extraction.

50. The process of claim 34, additionally comprising a downstream step selected from the group consisting of preparation of premium sweet crude oil; preparation of syngas; preparation of low sulfur, low metals coke; preparation of a low sulfur, low metals bottoms stream as fuel for combustion or gasification; production of very low sulfur naphtha, distillate and gas oil.

51. The process of claim 34, wherein sodium is recovered from and recycled for use in the desulfurization step.

52. A process for production of very low sulfur heavy crude oil comprising the steps of:
extraction of heavy oil, bitumen or bitumen froth with a solvent in which a fraction of the asphaltenes is insoluble, to remove from 5 to 50 weight % asphaltenes, forming a substantially dewatered deasphalted oil containing less than 500 weight parts per million (wppm) filterable solids and less than 0.1 weight % water; and
desulfurization of the substantially dewatered deasphalted oil using sodium metal desulfurization to produce a very low sulfur heavy crude oil.

53. The process of claim 52, wherein the substantially dewatered deasphalted oil produced in the step of extraction contains less than 200 wppm filterable solids.

54. The process of claim 52, wherein the substantially dewatered deasphalted oil produced in the step of extraction contains less than 0.01 weight % water.

55. The process of claim 52, wherein from 5 to 25 weight % asphaltenes are removed in the step of extraction.

56. A process for production of very low sulfur heavy crude oil comprising the steps of:
extraction of heavy oil, bitumen or bitumen froth with a paraffinic solvent to remove from 5 to 50 weight % asphaltenes, forming a substantially dewatered deasphalted oil containing less than 500 weight parts per million (wppm) filterable solids and less than 0.1 weight % water; and
desulfurization of the substantially dewatered deasphalted oil using alkaline earth or alkali metal desulfurization to produce a very low sulfur heavy crude oil.

57. The process of claim 56, wherein the substantially dewatered deasphalted oil produced in the step of extraction contains less than 200 wppm filterable solids.

58. The process of claim 56, wherein the substantially dewatered deasphalted oil produced in the step of extraction contains less than 0.01 weight % water.

59. The process of claim 56, wherein from 5 to 25 weight % asphaltenes are removed in the step of extraction.

60. The process of claim 56 wherein the alkali metal desulfurization includes alkali metals comprising potassium, lithium or a combination thereof.

61. The process of claim 60 wherein the alkali metal additionally comprises sodium.

62. The process of claim 56 wherein the alkaline earth metal desulfurization includes alkaline earth metals comprising calcium, magnesium or a combination thereof.

63. A very low sulfur heavy crude oil comprising less than 0.1 weight % water, less than 0.5 weight % sulfur, and from 15° to 20° API.

64. The oil of claim 64 comprising less than 0.1 weight % sulfur.

65. The oil of claim 64 comprising less than 0.01 weight % sulfur.

66. The oil of claim 64 comprising less than 0.01 weight % water.

67. The oil of claim 64 comprising less than 50 wppm metals.

68. The oil of claim 67 comprising less than 25 wppm metals.

69. A very low sulfur heavy crude oil produced according to the process of claim 34 having from 15° to 20° API.

70. A very low sulfur heavy crude oil produced according to the process of claim 52 having from 15° to 20° API.

71. A very low sulfur heavy crude oil produced according to the process of claim 56 having from 15° to 20° API.
